(19) United States
(12) Patent Application Publication
(10) Pub. No.: US 2021/0006122 A1
(43) Pub. Date: Jan. 7, 2021

(54) CAPILLARY-COOLED MOLDED MAGNETIC STRUCTURE

(71) Applicant: PRIPPELL TECHNOLOGIES, LLC, Los Angeles, CA (US)

(72) Inventor: Eric E. Rippel, Los Angeles, CA (US)

(21) Appl. No.: 16/783,085

(22) Filed: Feb. 5, 2020

Related U.S. Application Data
(63) Continuation of application No. 16/452,345, filed on Jun. 25, 2019, now abandoned.
Application No. 16/452,345 is a continuation of application No. 16/380,624, filed on Apr. 10, 2019, now abandoned.
(60) Provisional application No. 62/656,222, filed on Apr. 11, 2018.

(51) Int. Cl. H02K 5/20; H02K 9/19

(52) U.S. Cl. CPC H02K 5/20; H02K 9/19

(57) ABSTRACT

A molded magnetic structure. In some embodiments, the molded magnetic structure includes a plurality of coolant flow channels.

### CROSS-REFERENCE TO RELATED APPLICATION(S)

The present application is a continuation of U.S. patent application Ser. No. 16/452,345, filed Jun. 25, 2019, entitled “CAPILLARY-COOLED MOLDED MAGNETIC STRUCTURE”, which is a continuation of U.S. patent application Ser. No. 16/380,624, filed Apr. 10, 2019, entitled “CAPILLARY-COOLED MOLDED MAGNETIC STRUCTURE”, which claims the benefit of U.S. Provisional Application No. 62/656,222, filed Apr. 11, 2018, entitled “CAPILLARY-COOLED MOLDED MAGNETIC STRUCTURE”, the entire contents of both of which are incorporated herein by reference.

### DETAILED DESCRIPTION OF FIGURES

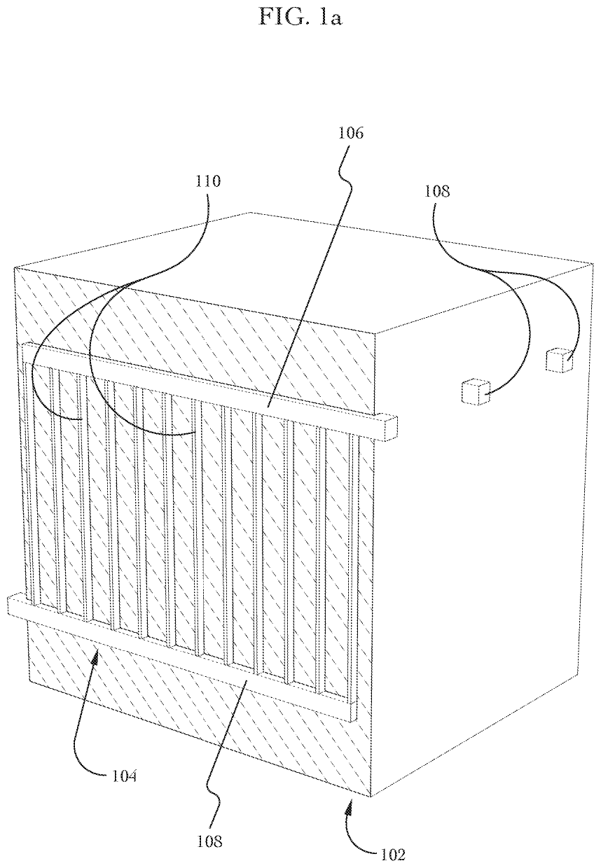

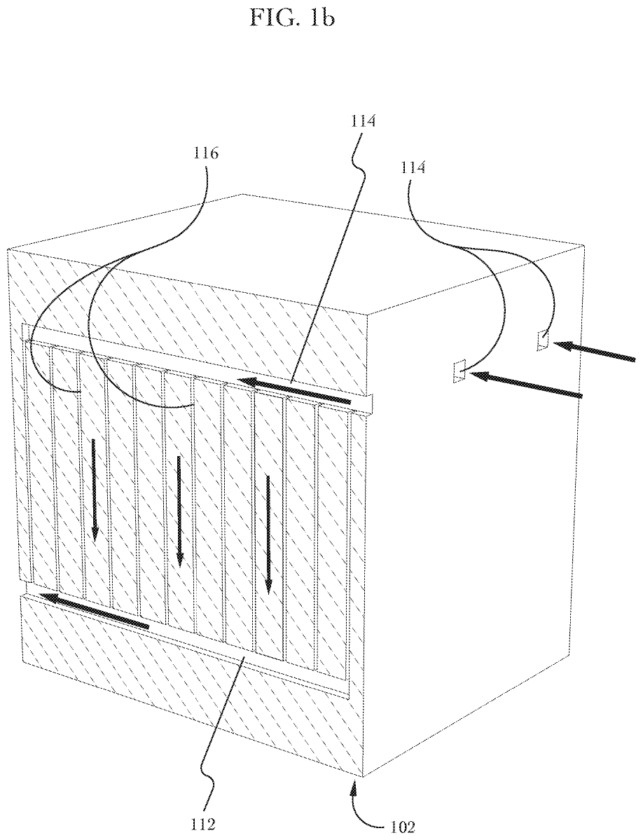

FIG. 1a shows a section of a capillary-cooled molded element 102 wherein coolant channels are established via one or more investment molds 104. In turn, each investment mold 104 includes one or more inlet mold elements 106, one or more outlet mold elements 108, and one or more capillary mold elements 110. Molded element 102 may be fabricated from a powder material which is compressed and heated to form a solid. In the case of magnetic components such as motor cores or transformer cores, a ferro-magnetic powder may be used. Various powder binders may be used to enhance desired properties such as thermal conductivity or modulus.

FIG. 1b shows a section of a capillary-cooled molded element 102 after investment mold(s) 104 have been removed. Channels formed by investment mold(s) 104 include inlet channel(s) 112, outlet channel(s) 114, and capillary channels 116. Investment mold 104 can be removed by chemical or thermal means; forced air may be used to help remove dissolved or melted material.

FIG. 1c shows composite capillary element 103 comprising individual capillary-cooled molded elements 120 and 122 where cooling channels are provided by surface grooves on molded elements 120 and 122. Channels are completed when an external surface, such as an enclosure, is brought in contact with the molded element. As shown, enclosure 124 surrounds molded element 122 such that grooves within molded element 122 become coolant flow channels. Likewise, molded element 122 surrounds molded element 120 such that grooves within molded element 120 become coolant flow channels. Specifically, inlet grooves 126 serve as inlet channels; outlet grooves 128 serve as outlet channels and capillary grooves 130 serve as capillary channels.

By maintaining large numbers of capillary channels, each having relatively small thickness dimensions, efficient heat transfer between the molded element and the coolant can be achieved. Furthermore, by using a relatively large number of inlet and outlet channels, capillary lengths can be kept relatively short—thus maintaining relatively low coolant head loss.

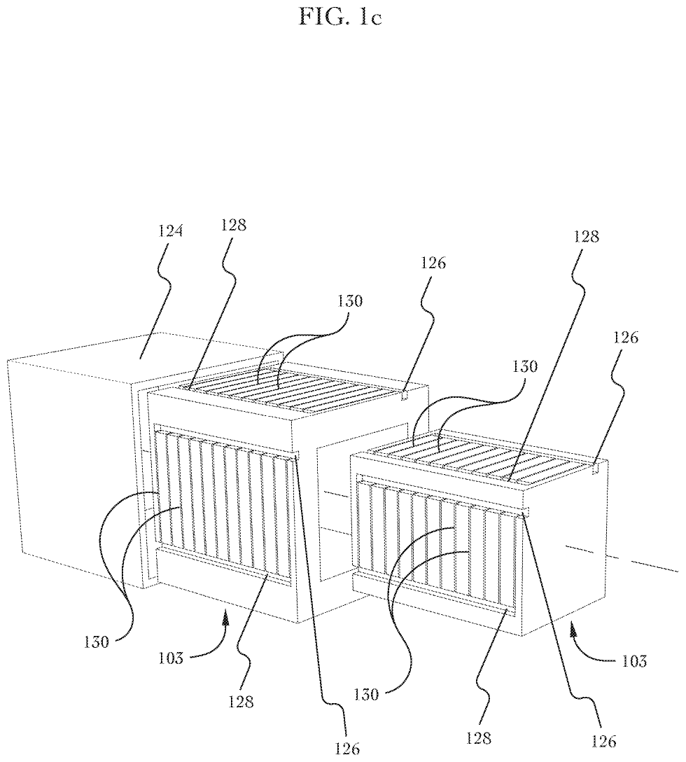

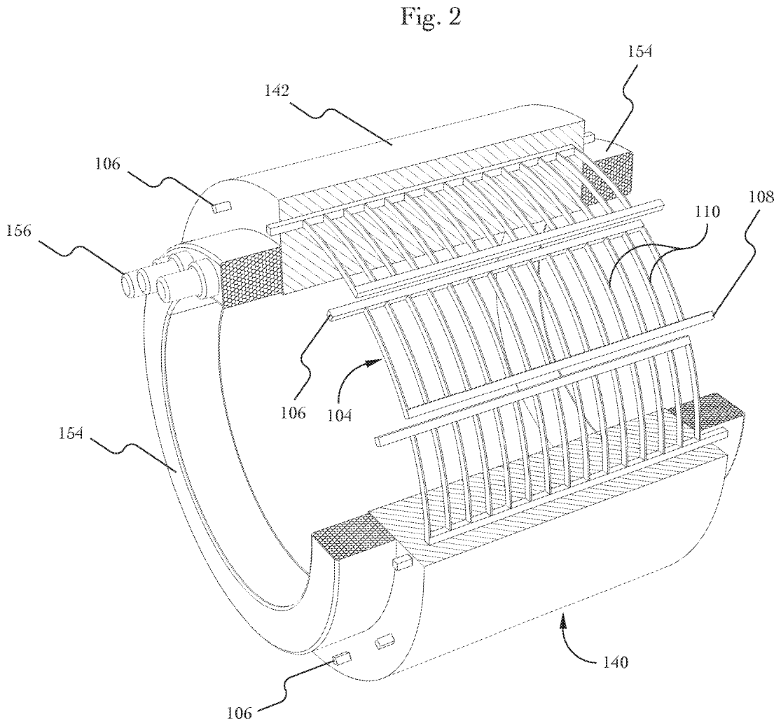

FIG. 2 shows an electric machine stator 140 comprising a molded ferromagnetic core 142 and a winding. In turn, the core includes a back iron portion 144 and a tooth portion. The winding includes active winding elements, end turn elements 154 and terminals 156. Cooling channels are formed within the back iron via investment mold(s) 104. Investment mold(s) 104 include inlet mold elements 106, outlet mold elements 108, and capillary mold elements 110. Upon dissolution of mold(s) 104, inlet, outlet and capillary channels are then present within back iron portion 144.

In some embodiments, the winding is first wound as a planar element with the active winding elements compressed and bonded. The winding is then formed into a cylindrical shape and then may be coated with a thermally conductive insulating material. The winding is then over-molded with the core material and finally, the investment molds are removed (either chemically or thermally). With this construction approach, very high winding packing can be achieved, especially for the active winding elements. Additionally, excellent heat transfer can be achieved between the winding and the core due to the intimate contact between the core and the winding.

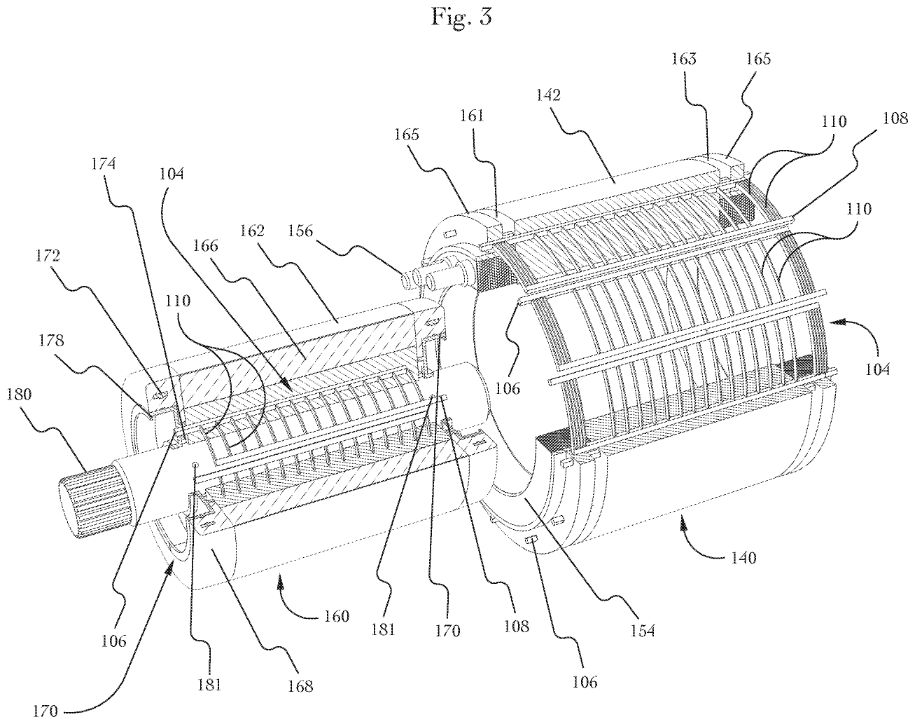

FIG. 3 shows cut-away views for a stator—rotor combination for an induction motor. Stator 140 is similar to that of FIG. 2 except that end turn cooler elements 165 have been added at each end of rotor core 142. End turn coolers 165 may be provided by simply extending molded core 142, or they may be completely separate elements. In the former case, cooling channels may be provided within end turn coolers via added capillary elements 112 within investment mold 104. In either case, end turn coolers 165 are in thermal contact with end turns 154 such that heat generated within end turns 154 is transferred to coolant flowing within end turn coolers 165. Coolant may be fed in at inlet gap 161 and retrieved at outlet gap 163.

Rotor 160 comprises molded rotor core 162, rotor cage 164, rotor manifolds 170, and rotor shaft 180. In turn, molded core 162 includes inlet, outlet and capillary channels which are formed by investment molds 104. Rotor cage 164 includes active rotor bars 166 and end rings 168. Rotor manifolds 170 include end ring capture elements 172 which extend into the end ring material to provide mechanical reinforcement (this feature may be advantageous in high speed applications). Rotor manifolds also include rotor manifold cavity 174 which enables coolant flow between rotor shaft 180 and inlet and outlet channels cast within rotor core 162. Radial shaft holes 181 within shaft 180 enable coolant flow to or from shaft 180. Rotor manifolds 170 may also include balance registers 178 which enable dynamic balancing by the addition of materials such as “balancing putty”.

In some embodiments, the combination of the cage and manifolds is cast or otherwise fabricated as a pre-formed element. This combination is then over-molded with core material followed by removal of investment mold 104 such that cooling channels within the rotor core are provided. Alternatively, rotor core 162 may first be molded as a separate element with the rotor cage subsequently added.

In some cases, a conventional lamination type rotor combined with a molded capillary-cooled stator may be advantageous. In other cases, the reverse may be called for—where the rotor uses a molded capillary-cooled core and the stator uses a conventional lamination structure.

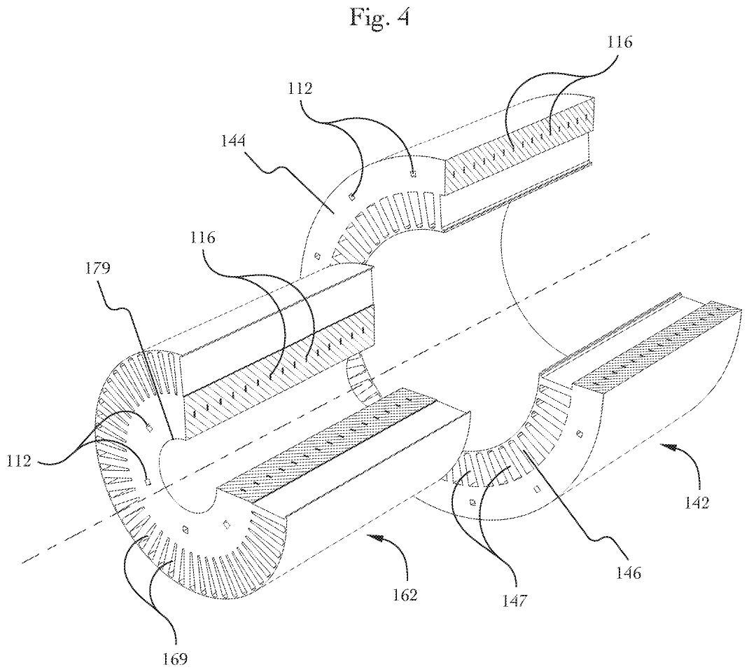

FIG. 4 is a cut-away view showing molded stator core 142 and molded rotor core 162. Stator core 142 includes closed winding slots 147 and molded rotor core 162 includes closed bar slots 169. As shown, for both the stator and rotor cores, inlet channels 112 exit one face, and outlet channels 114 exit the opposite face. Inlet and outlet channels are connected via capillary channels 116 such that all coolant flow must flow through these capillary channels.

Since the stator winding is over-molded with the the core material, conventional tooth gaps are no longer needed. This may provide benefit in terms of reduced tooth tip and winding eddy losses.

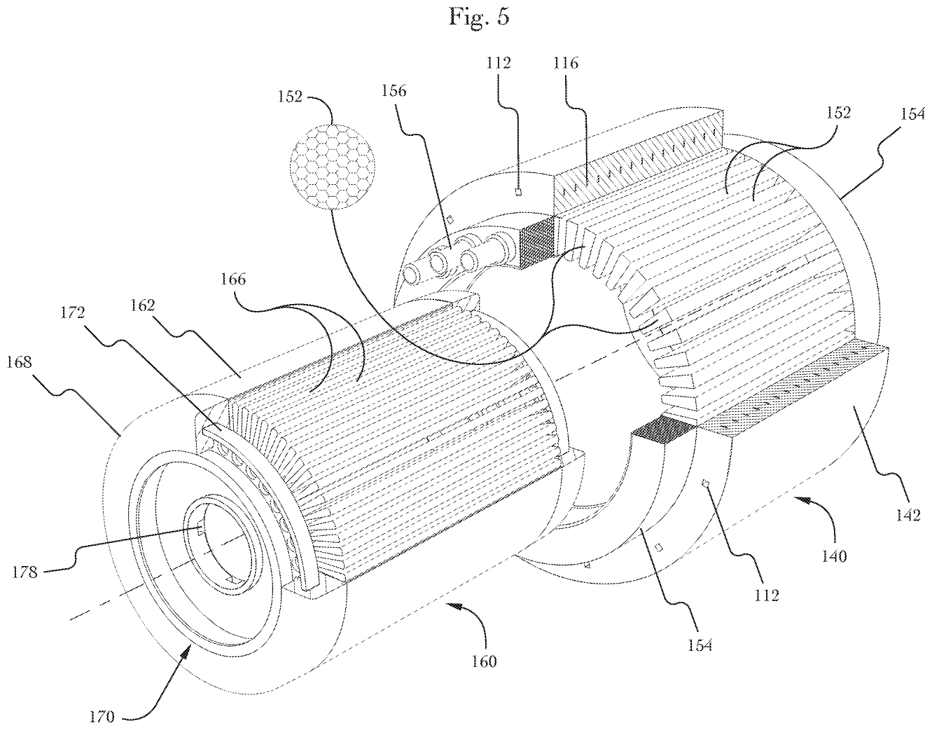

FIG. 5 is a cut-away drawing for the combination of an induction machine stator 140 and rotor 160. As shown, the stator consists of molded core 142 and winding 150. The winding is pre-formed and the core is then molded over the winding. Active winding elements 152 may be compressed and bonded to form rigid elements of high packing density and thermal conductivity. End turn portions 154 of the winding may also be compacted.

Coolant channels are molded into the back-iron portion of the stator core 142. These include axially directed inlet and outlet channels 112 and 114 which are alternately disposed. Capillary channels 116 interconnect adjacent inlet and outlet channels. The stator winding is terminated via terminals 156.

Rotor 160 comprises a molded rotor core 162, rotor cage 164, and rotor manifolds 170. In turn, rotor cage 164 comprises active rotor bars 166 and end rings 168. Finally, rotor manifolds 170 comprise end ring capture elements 172, manifold cavities 174, and rotor manifold registers 178. Inlet, outlet, and capillary channels may be included within molded core 162 for heat removal. Inlet channels receive coolant from an inlet manifold cavity 174, while outlet channels deliver coolant to an outlet manifold cavity 174. In turn, both of these manifold cavities are contiguous with respective radial shaft holes 181 (FIG. 3).

End ring capture elements are peripheral manifold features which serve to reinforce end rings 168 such that high speed operation can be safely achieved. Manifold register 178 is a feature which allows the addition of balancing putty such that dynamic balancing can be easily achieved.

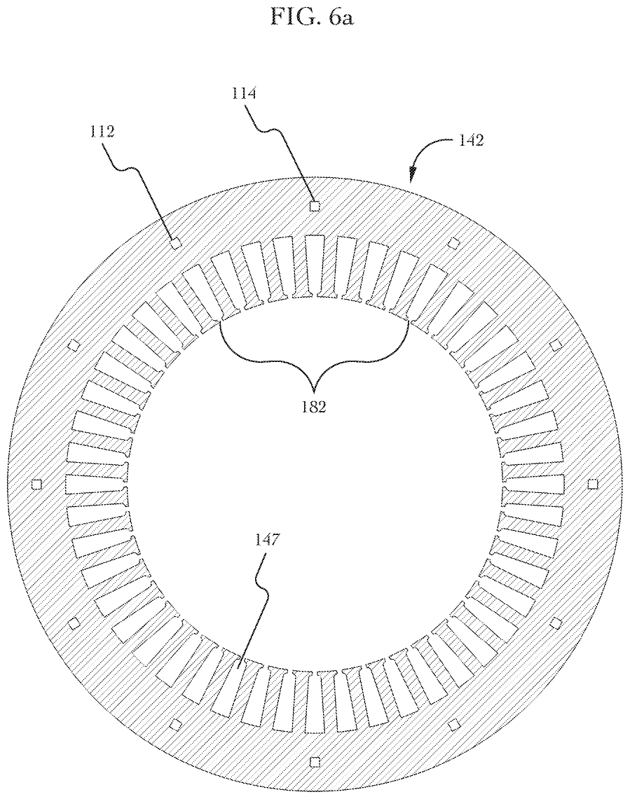

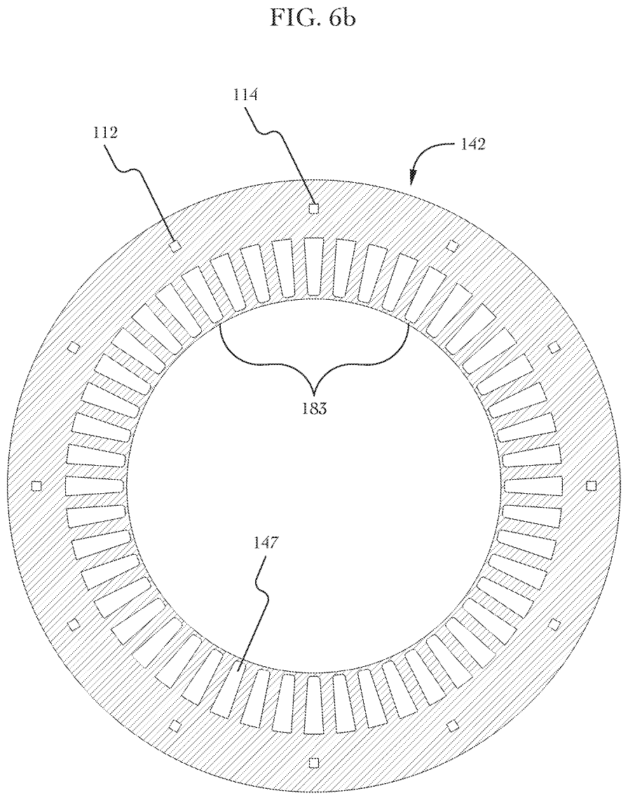

FIG. 6a shows a molded stator core section in the case where stator core 142 is formed separately such that a conventional winding can be added. Tooth gaps 182 are present such that winding conductors can be inserted into the winding slots. Cooling channels are similar to those described under FIGS. 4 and 5.

FIG. 6b shows the stator core section in the case where stator core 142 is molded over the winding. Tooth gaps are typically absent and are replaced with bridge elements 183. With tooth slots bridged by core material, tooth tip losses are reduced thus providing both thermal and efficiency benefits. On the down-side, magnetic flux linkage between the stator and rotor may be reduced because of these tooth bridges—which, in turn, may reduce peak torque capability. Cooling channels are similar to those described in connection with FIGS. 4 and 5.

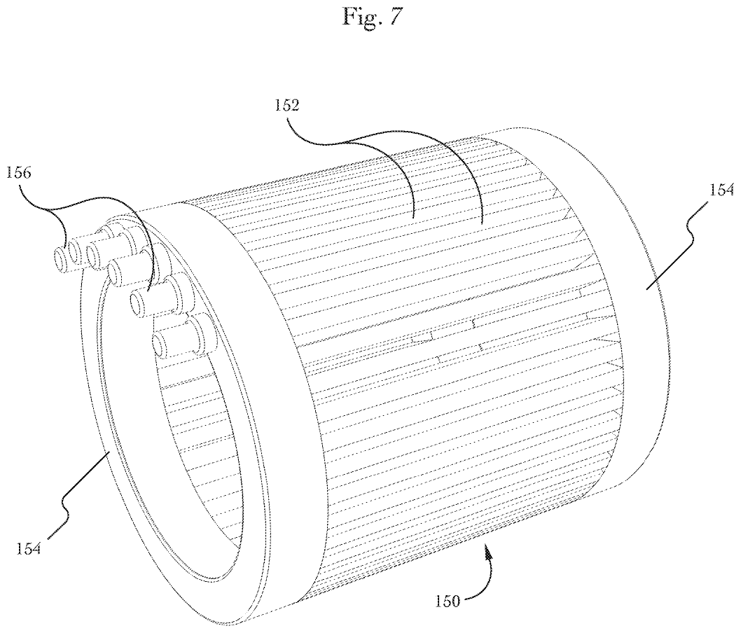

FIG. 7 shows a complete pre-formed winding 150 prior to over-mold of the core.

Winding elements shown include active portions 152, end turn portions 154, and terminals 156. It should be noted that stators for induction and brushless motors are typically quite similar. As such, stators described in this disclosure are applicable to either machine type.

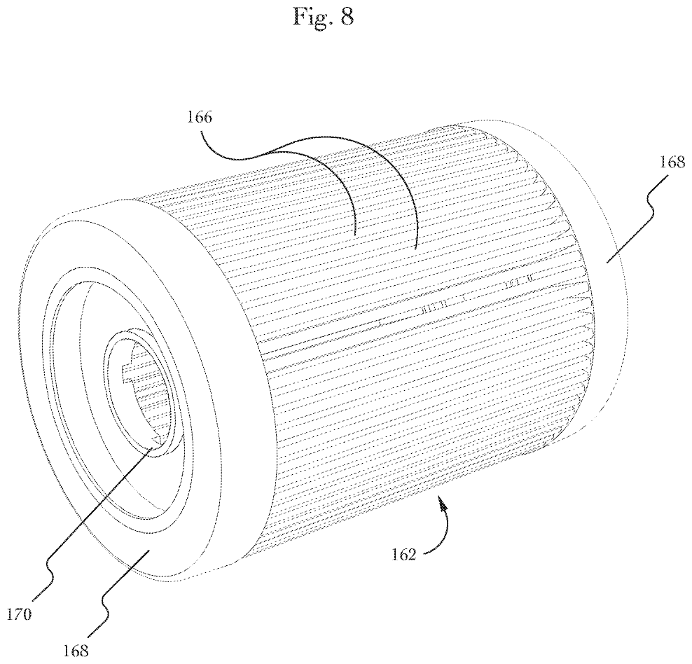

FIG. 8 shows a complete pre-formed rotor cage 164 prior to over-mold of the core material. Cage elements include active rotor bars 166, end rings 168 and rotor manifolds 170. In some embodiments, the cage (combination of rotor bars and end rings) is assembled along with rotor manifolds 170. With this construction approach, the rotor investment mold (not shown) may be incorporated within the cage during assembly. After the core material is over-molded, the investment mold is then removed—either by melting or by chemical dissolution.

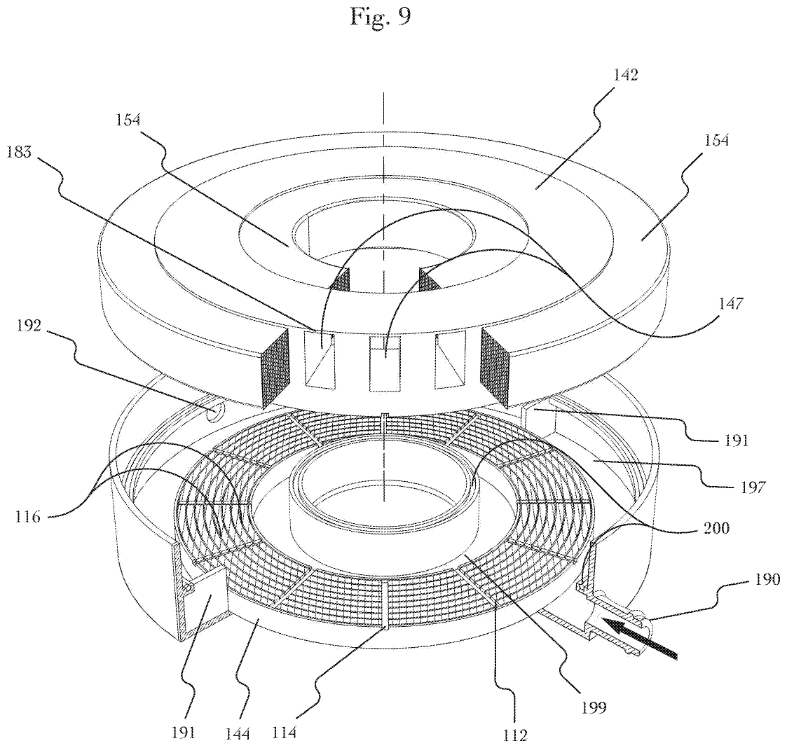

FIG. 9 shows an exploded view of an axial gap stator 184 which consists of molded ferromagnetic core 142, winding 150, manifold housing 186, inlet 190, and outlet 192. In turn, core 142 consists of a back iron portion 144 (located at the bottom) and tooth portions 146 (located at the top) which, in turn, contain winding slots 147. Likewise, winding 150 comprises active winding elements 152 and end turn elements 154.

Inlet 190 introduces coolant flow into a first outer manifold cavity 194 from where it flows to radially directed inlet channels 112 and then on to azimuthal capillary channels 116. Coolant is then received by outlet channels 114 and directed to inner manifold cavity 199 where it then flows to a second set of inlet channels 112, then on to a second set of capillary channels 116 and finally is received by a second set of outlet channels 114 from where is then passed on to a second outer manifold cavity 196 and finally to outlet 192. Partitions 191 isolate outer manifold cavities 194 and 196 such that all flow is forced to take the path described above.

In some embodiments, winding 150 is pre-formed and core 142 is molded over the winding. Alternatively, a core, which includes slot gaps, may be pre-formed such that the winding can be inserted in winding slots using conventional means.

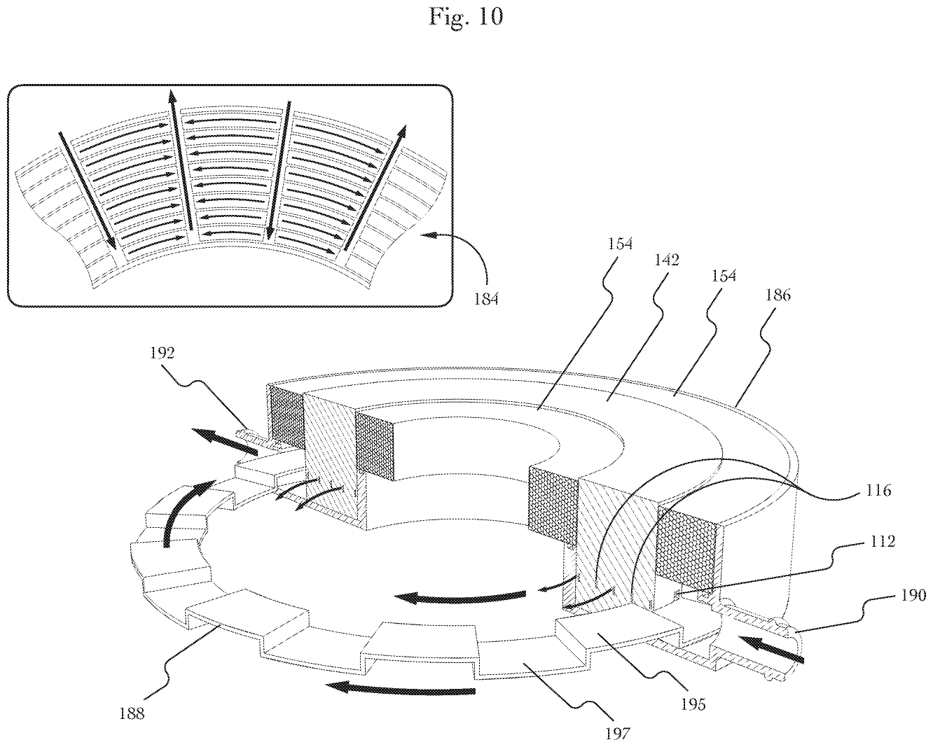

FIG. 10 is a half section of an axial gap stator 184 which consists of molded ferromagnetic core 142 and winding 150. In turn, core 142 consists of a back iron portion 144 and a tooth portion 146. The back iron portion includes internal cooling channels consisting of inlet channels 112, outlet channels 114 and interconnecting capillary channels 116.

Core 142 is held in place by manifold housing 186. Inlet and outlet flow is directed and constrained by cavities formed by manifold housing 186 and flow director 188. Upper cavity 195 receives coolant flow from inlet 190 and distributes coolant flow to radial inlet channels 112. Likewise lower cavity 196 receives coolant flow from outlet channels 114 and delivers this flow to outlet 192.

The upper left detail shows a section of core 142 where inlet channels 112, outlet channels 114 and capillary channels 116 are seen; arrows represent coolant flow.

Winding end turns 154 may be in thermal contact with manifold housing 186 such that a portion of the heat generated within the end turn is transferred to the manifold housing.

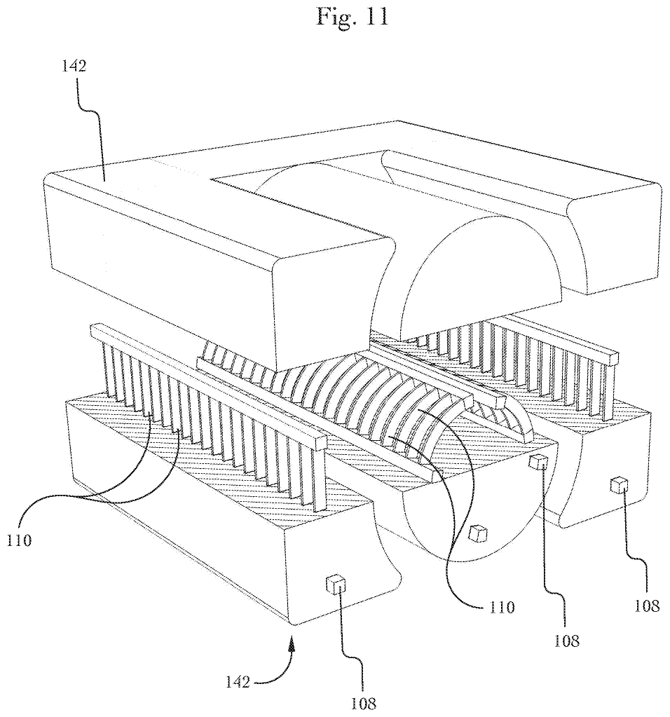

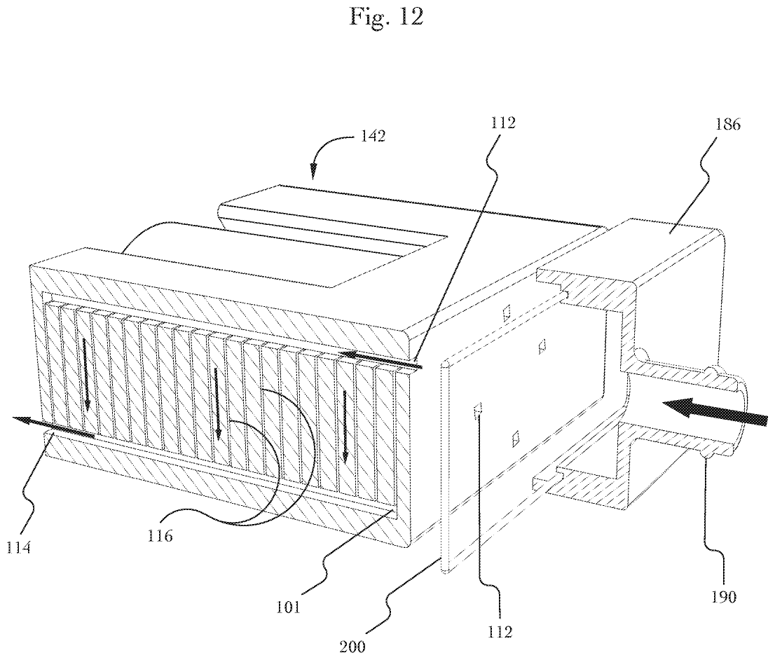

FIG. 11 is an exploded view of a magnetic core 142 which can be used for inductors or transformers. As with the previously described items, the core is molded from a ferromagnetic material which is molded over investment mold 104 such that inlet channels 112, outlet channels 114 and capillary channels 116 are formed. In turn, investment mold(s) 104 include inlet mold elements 106, outlet mold elements 108 and capillary mold elements 110. Heat produced within an associated winding is transferred primarily to the core. The winding may be pressure potted with a thermally conductive resin to enhance thermal conductivity within the winding and between the mating surfaces of the winding and the core.

FIG. 12 is a sectional view of the capillary-cooled magnetic core 142 shown in FIG. 11. Inlet channel 112, outlet channel 114 and capillary channels 116 are visible at the plane of the section. Housing manifold 186 serves to distribute flow received by inlet 190 to inlet channels 112. Needed fluid sealing is provided by O-ring 200.

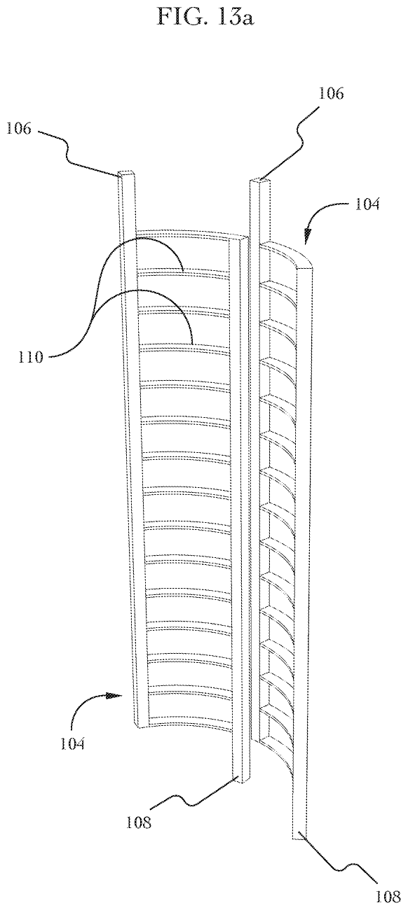

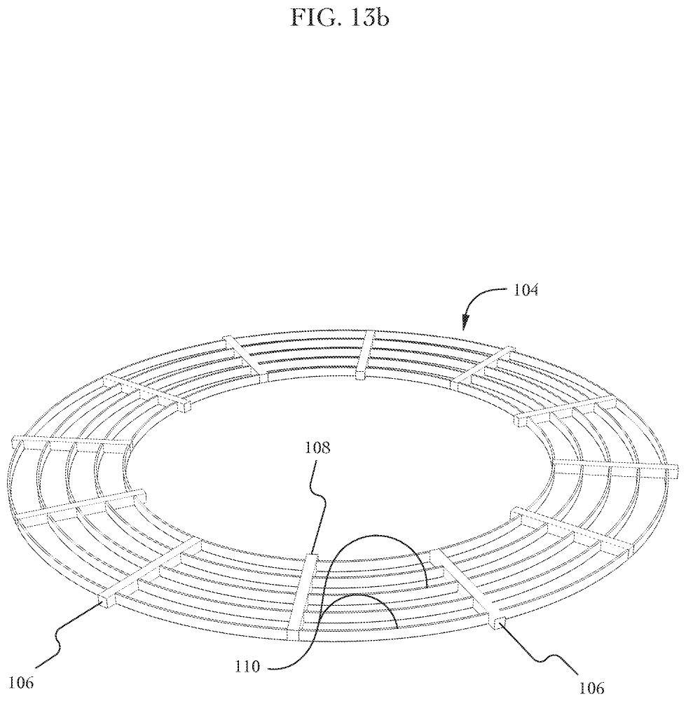

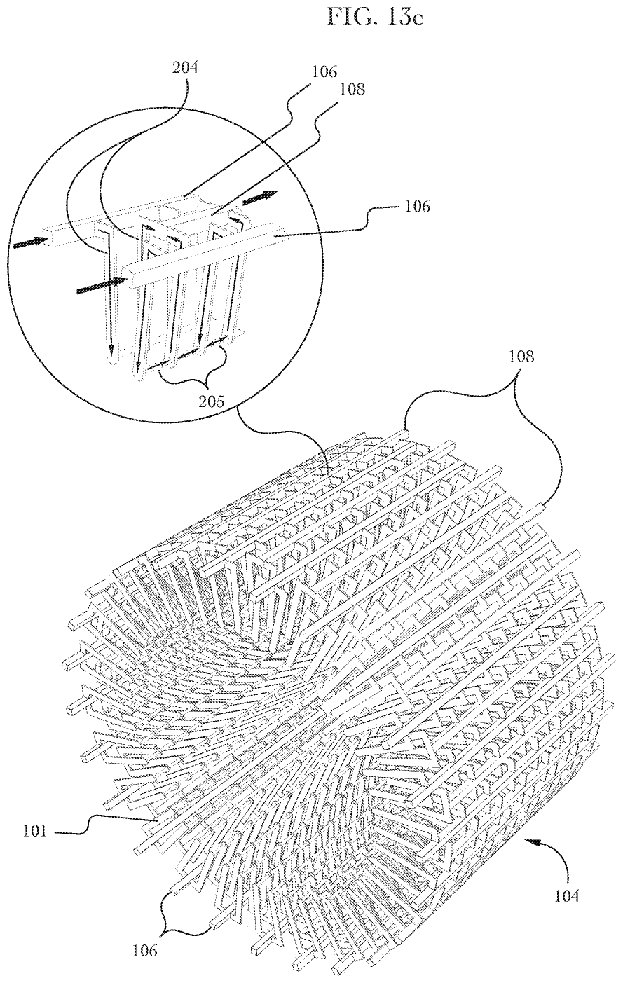

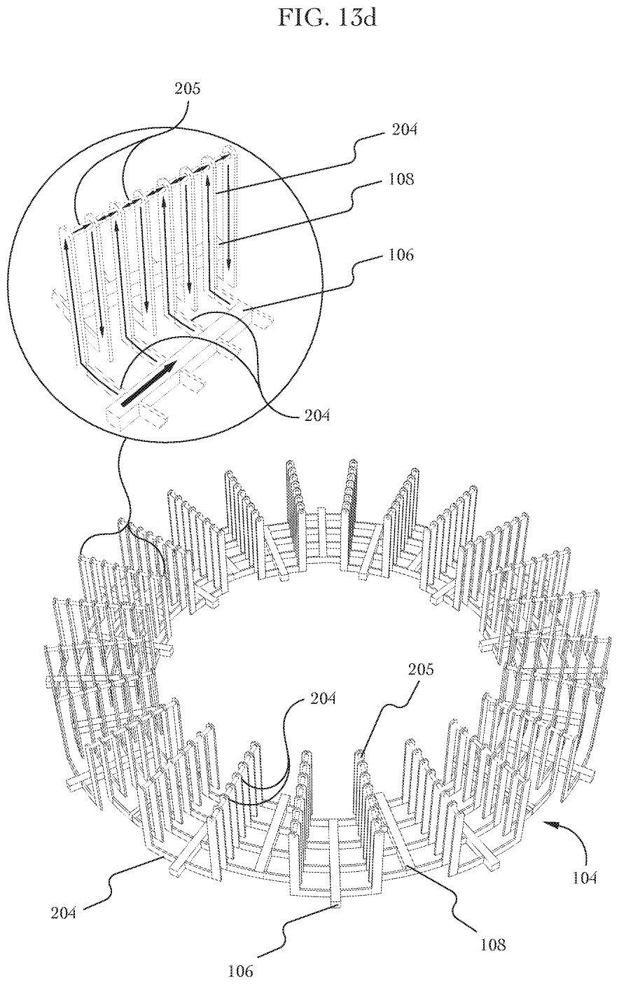

FIG. 13a shows investment mold 104 as used in connection with the center prong for core elements shown in FIGS. 11 and 12. Each mold element 104 includes inlet mold element 106, outlet mold element 108, and multiple capillary mold elements 110.

FIG. 13b likewise shows investment mold 104 as used in connection with the axial gap stator core elements shown in FIGS. 9 and 10. Each mold element includes inlet mold elements 106, outlet mold elements 108, and multiple capillary mold elements 110.

FIG. 13c shows investment mold 104 used in connection with a tooth-cooled radial gap electric machine stator. The mold consists of multiple inlet mold elements 106, outlet mold element 108, radial capillary mold elements 204, and axial capillary elements 110. The resulting mold inlet and outlet mold channels are interconnected by a series combination of radial and axial capillary channels which are formed respectively by radial capillary mold elements 204 and axial capillary mold elements 110.

The resulting coolant channels provided by investment mold 104 provide high contact surface area combined with short flow length. Tooth tips are efficiently cooled as associated heat flow lengths are quite short. This in turn provides for a low thermal impedance combined with low head loss.

FIG. 13d shows investment mold 104 used in connection with a tooth-cooled axial gap electric machine stator. The mold consists of multiple inlet mold elements 106 and outlet mold element 108. The resulting mold inlet and outlet mold channels are interconnected by a series combination of axial capillary channels 211 and radial capillary channels 213 which are formed respectively by axial capillary mold elements 207 and radial capillary mold elements 209.

The resulting coolant channels provided by investment mold 104 provide high contact surface area combined with short flow length. Tooth tips are efficiently cooled as associated heat flow lengths are quite short. This in turn provides for a low thermal impedance combined with low head loss.

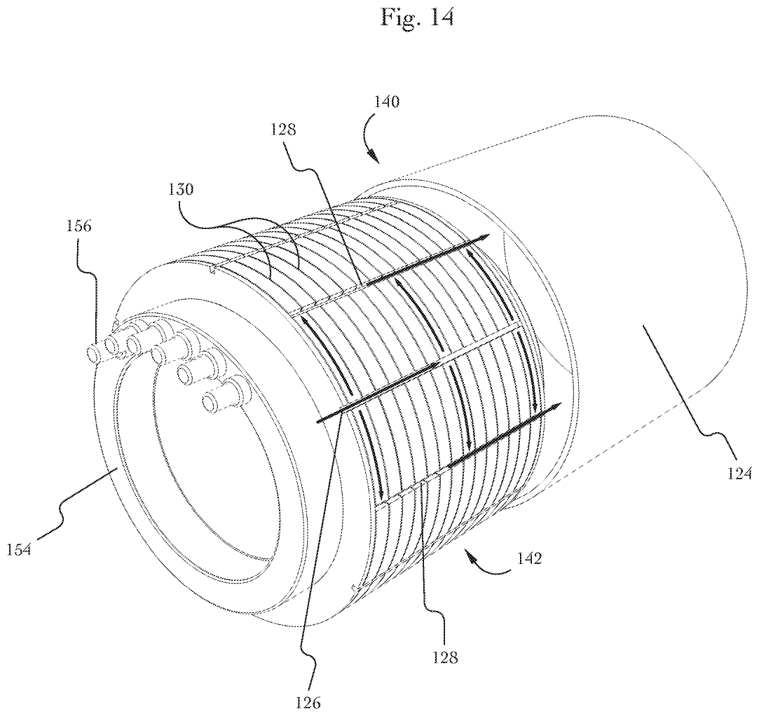

FIG. 14 shows a radial gap electric machine stator where surface grooves are molded into the core element to provide cooling channels for coolant. Specifically, electric machine stator 140 comprises a molded ferromagnetic core 142 and winding 150. In turn, molded ferromagnetic core 142 includes a back iron portion 144 and a core tooth portion 146. The outer surface of molded core 142 includes inlet grooves 126, outlet grooves 128, and capillary grooves 130; capillary grooves 130 provide flow channels between adjacent inlet and outlet grooves. Enclosure 124 fits tightly over core 142 such that inlet, outlet and capillary grooves become enclosed channels.

Winding 150 consists of active winding elements 152 and end turn elements 154. Active winding elements 152 fit between adjacent core teeth. The winding is shown as an “open delta”—wherein no neutral splice is used; alternative winding arrangements are possible. Winding conductors terminate with terminal pins 156. Manifolds used to direct inlet flow into inlet channels and to collect coolant from outlet channels are not shown.

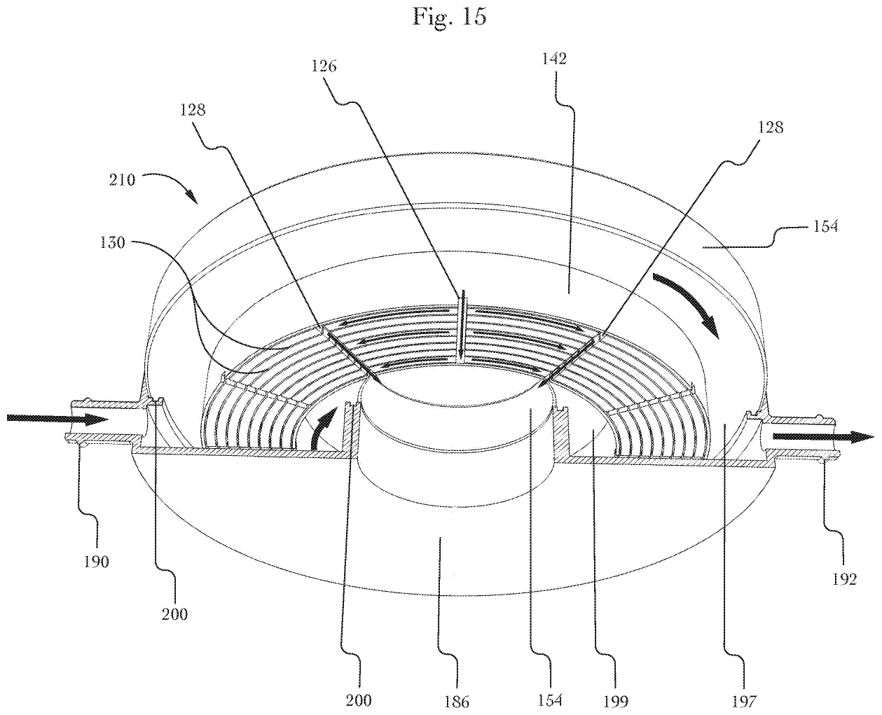

FIG. 15 is a cut-away view of an axial gap machine stator where surface grooves are molded into the core element to provide cooling channels. Specifically, electric machine stator 140 comprises a molded ferromagnetic core 142 and winding 150. In turn, molded ferromagnetic core 142 includes a back iron portion 144 and a core tooth portion 146. The outer surface of molded core 142 includes inlet grooves 126, outlet grooves 128, and capillary grooves 130; capillary grooves 130 provide flow channels between adjacent inlet and outlet grooves. Both the inlet and outlet grooves are blocked at the I.D. The core and winding are held in place by manifold housing 186. Annular flow director 188 in combination with manifold housing 186 serves to create two cavities within manifold—upper manifold cavity 194 and lower manifold cavity 196. Flow director 188 is shaped such that flow received from inlet 190 is directed to inlet channels 112 formed by inlet grooves 126. Likewise, flow director 188 also serves to direct flow received from outlet channels 114 formed by grooves 128 to outlet 192.

In some embodiments, the number of capillary channels is large compared with the number of inlet or outlet channels such that the wall area associated with the capillary channels is large compared with that of the inlet or outer channels. Likewise, the thickness of the capillary channels is relatively small compared with either the inlet or outlet channels. Since heat transfer is proportionate to heat flow area divided by heat flow distance, it follows that the majority of heat transfer is due to the capillary channels. In, some such embodiments the majority of head loss is due to laminar viscous effects caused by coolant flow through the capillary channels. Since head loss is proportionate to the length of the capillary channels, it is desirable to maintain short capillary lengths. This in turn means that the number of inlet and outlet channels should be as large as practically possible.

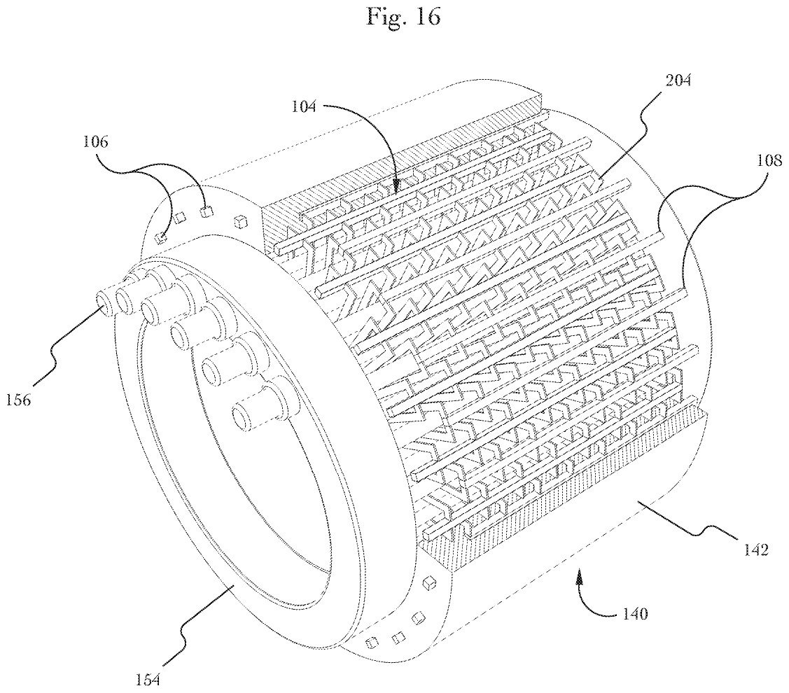

FIG. 16 shows a radial gap electric machine stator 140 which corresponds to mold elements shown in FIG. 13c. The stator is composed of molded ferromagnetic core 142 and winding 150. In turn, molded ferromagnetic core 142 is composed of back iron portion 144 and tooth portion 146. Likewise, winding 150 is composed of active winding elements 152 and end turn elements 154.

Inlet channels 112 transport coolant from a manifold (not shown) to multiple feeder channels 204, located within stator teeth (not shown) which then radially direct coolant to capillary channels 116 which are oriented axially within tooth tips—from where coolant then flows to a second set of feeder channels 206 and on to outlet channels 114—where it is then collected by a manifold (not shown). Heat transfer between the core and coolant is primarily due to feeders 204 and capillary channels 116.

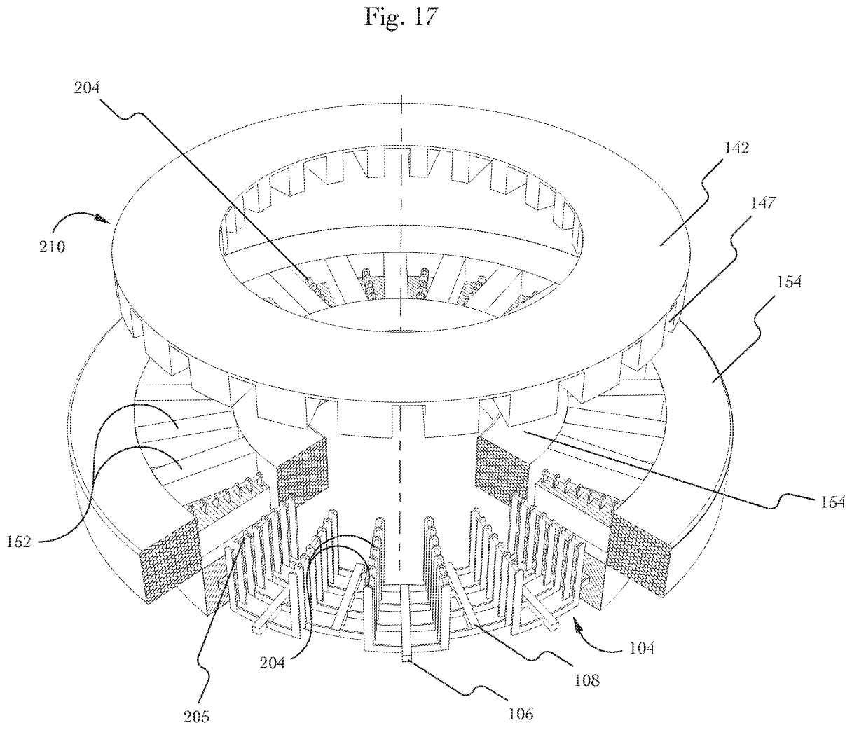

FIG. 17 is an exploded cut-away view of an axial gap electric machine stator 140 fabricated using mold elements shown in FIG. 13d. The stator is composed of molded ferromagnetic core 142 and winding 150. In turn, molded ferromagnetic core 142 is composed of back iron portion 144 and tooth portion 146. Likewise, winding 150 is composed of active winding elements 152 and end turn elements 154.

Inlet channels 112 transport coolant from a first manifold (not shown) to multiple feeder channels 206, located within stator teeth (not shown) which then axially direct coolant to capillary channels 116 which are radially oriented within tooth tips. Coolant then collected by a second set of feeder channels 204 and passed on to outlet channels 114—where it is then collected by a second manifold (not shown). Heat transfer between the core and coolant is primarily due to feeders 204 and capillary channels 116.

In some embodiments the capillary channels 116 have a cross section that is rectangular or oblong with a smaller dimension selected to be sufficiently small to provide good heat transfer without excessive head loss. For example, each of the capillary channels 116 may have a smaller dimension between 0.010 inches and 0.050 inches (e.g., a smaller dimension of 0.025 inches) and the the capillary channels 116 may be spaced apart by between 0.050 inches and 0.200 inches (e.g., by 0.100 inches). Each inlet channel 112 may have a cross sectional shape and size that allows fluid to flow to a plurality of capillary channels 116 without excessive head loss, e.g., each channel may be approximately square, or round, with a cross sectional dimension (e.g., diameter, or square side length) of between 0.100 inches and 0.200 inches (e.g., a cross sectional dimension of 0.125 inches). The outlet channels 114 may have similar shapes and sizes.

What is claimed is:

1. A molded magnetic structure, comprising a plurality of coolant flow channels.
